(19) United States
(12) Patent Application Publication
(10) Pub. No.: US 2009/0218210 A1
(43) Pub. Date: Sep. 3, 2009

(54) ENERGY-EFFICIENT DISTILLATION SYSTEM

(76) Inventors: Laura Demmons, Menlo Park, CA (US); Eugene Thiers, San Mateo, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/090,248

(22) PCT Filed: Oct. 16, 2006
(86) PCT No.: PCT/US06/40553

§ 371 Date: Sep. 9, 2008

Related U.S. Application Data
(60) Provisional application No. 60/727,106, filed on Oct. 14, 2005.
(60) Provisional application No. 60/748,496, filed on Dec. 7, 2005.

(51) Int. Cl. B01D 1/30; B01D 3/00; B01D 5/00; B01D 19/00

(52) U.S. Cl. 203/22; 202/177

(57) ABSTRACT

Methods and devices are provided for an energy-efficient distillation system (42). An energy-efficient distillation system (42) can include a fluid inlet (24), one or more heat-yielding purification elements (7, 15, 44) downstream of the fluid inlet (24), one or more heat pipes (6), and a fluid outlet (23) downstream of the heat-yielding purification element (7, 15, 44). The heat-yielding purification element (7, 15, 44) can be, for example, a degasser (7), a demister (15), or an evaporation chamber (44). A heat pipe (6) has a first end operably connected to the heat-generating purification element(s) (7, 15, 44), a second end operably connected to the fluid inlet (24), and a body therebetween. The heat pipe (6) is configured to transfer latent heat energy from the first end to the second end, thereby heating a fluid (8) within the fluid inlet (24). The distillation system (42) can also include one or more descaling elements (21) for reducing scale formation of the fluid (8).

### RELATED APPLICATIONS

This application claims the benefit under 35 U.S.C. § 119 of U.S. Provisional Application No. 60/727,106 filed Oct. 14, 2005 and U.S. Provisional Application No. 60/748,496 filed Dec. 7, 2005. The priority applications are hereby incorporated by reference herein in their entirety.

### BACKGROUND OF THE INVENTION

1. Field of the Invention

This invention relates to an energy efficient distillation system.

2. Description of the Related Art

All distillation systems used for water purification rely on the evaporation of water containing contaminants, so as to produce steam which is essentially free of contaminants. This evaporation process is energy intensive because of the high value of the latent heat of evaporation of water at boiling temperatures of 100 degrees Celsius (100° C.), or 212 degrees Fahrenheit (212° F.), which is known to be 539.55 calories per gram (971.19 Btu/lb). This amount of energy is in addition to the energy required to bring water temperatures to the boiling point, which depends on the temperature of the feed water. Accordingly, most conventional distillation systems attempt to recover some of this energy by using heat exchangers.

Conventional heat exchangers have different configurations, sizes, efficiencies and cost, depending on how heat is exchanged between a hot and a cold fluid. For example, conventional heat exchangers include tube and frame, coaxial tube, or flat plate exchangers, to name a few, and they can be further classified into co-current, cross-current, or counter-current types, depending on the direction of flow of the two fluids in a given configuration. An example of a system using plate heat exchangers can be found in U.S. Pat. No. 6,663,770 to Sears, which is herein incorporated by reference in its entirety. However, all heat exchangers rely on the same physical principle of heat conductivity to transfer heat from a hot to a cold fluid or gas. Heat conductivity is defined as the time rate of transfer of heat by conduction through a unit of thickness and across a unit of area per unit difference of temperature, and is normally expressed as the specific heat conductivity of a material in terms of calories/cm ° C. (Btu/inch ° F.).

Because conductivity is the basic mechanism of heat transfer for all heat exchangers, they are normally designed to maximize the surface area of contact between the hot and cold fluid, and the consequence of such design is that heat exchangers are generally bulky, heavy, and expensive pieces of equipment. In addition, large surfaces that are warmer than the surrounding air lose heat to the environment and, since cost limits the amount of surface area that can be provided in any given configuration, heat exchangers typically have low thermal efficiencies, of the order of 80% to 90%.

Current distillation systems are also plagued by the problem of calcareous deposits known as scale, which result from the evaporation of water that commonly contains calcium, magnesium, and/or phosphate ions; and subsequent precipitation of those ions as salts.

Such scale deposits, which can be in the form of calcium or magnesium carbonates or the corresponding phosphates, are generally poor thermal conductors and reduce the efficiency of heat transfer in distillation systems, and they also plug conduits, thus increasing maintenance costs. As a result, most distillation systems that are commercially available specify low hardness water for proper operation, or else require water softening as a prerequisite. However, conventional water softening is normally effected by ion exchange of calcium or magnesium with sodium, and thus yields water that is high in sodium content. In addition, softening water by ion exchange is an additional task that requires periodic restoration of the ion exchange media, and is costly.

What is needed is a mechanism for heat recovery that is not limited to heat conductivity, that can efficiently transfer large amounts of heat per unit of surface, and that is relatively inexpensive to manufacture. Furthermore, what is needed is a mechanism for handling hard water in distillation systems that does not change the composition of the water, but that effectively prevents scale formation in the distillation unit. A further desirable feature of such a mechanism is that it should be inexpensive to operate. It is the purpose of this invention to provide for effective heat recovery in water distillation systems that include degassing, demisting, boiling, and condensing operations. A further purpose of this invention is to provide an inexpensive method of preventing scale formation in distillation systems, particularly those that include degassing, demisting, boiling, and condensing operations.

### SUMMARY OF THE INVENTION

Disclosed herein is an energy-efficient distillation system. The system includes a fluid inlet, a heat-yielding purification element downstream of the fluid inlet, a first heat pipe, and a fluid outlet downstream of the heat-yielding purification element. The first heat pipe has a first end, a second end, and a body therebetween. The first end of the first heat pipe is operably connected to the heat-yielding purification element. The second end of the first heat pipe is operably connected to the fluid inlet. The first heat pipe is configured to transfer latent heat energy from the first end to the second end, thereby heating a fluid within the fluid inlet. The fluid outlet is configured to receive a purified fluid from the heat-yielding purification element. In some embodiments, the heat-yielding purification element can be a degasser, a demister, an evaporation chamber, or a condenser. In some embodiments, the distillation system includes a second heat pipe. The second heat pipe has a first end, a second end, and a body therebetween. The second heat pipe is operably connected to the fluid outlet at a first end and the fluid inlet at a second end. The second heat pipe is configured to transfer latent heat energy from the fluid outlet to the fluid inlet, thereby heating the fluid within the fluid inlet. In some aspects, the distillation system can include a descaling element configured to reduce scale formation of the fluid. Scale formation can be reduced using magnetic energy, electromagnetic energy, or electrical energy. A heat pipe can be configured to withstand a vacuum of between about 0-760 mm Hg without collapse. In some embodiments, the heat pipe can be configured to withstand a vacuum of between about 100-700 mm Hg without collapse. The heat pipe can be made of a metal, which is stainless steel in some embodiments. The heat pipe can also include capillary media.

Also disclosed herein is a method of recovering heat within a fluid distillation system. The method includes passing fluid through a heat-yielding purification element of the fluid distillation system. Latent heat energy can be absorbed from the heat-yielding purification element. The latent heat energy can then be transferred from the heat-yielding purification element to a fluid within the fluid inlet of the fluid distillation system without direct contact between the fluid inlet and the purification element, causing the fluid to be heated. In some aspects, also included is the step of reducing scale formation of the fluid by exciting ions within the fluid. Exciting ions within the fluid can be performed using magnetic energy, electromagnetic energy, or electrical energy in some embodiments. In some aspects, absorbing latent heat energy from the heat-yielding purification element and transferring the latent heat energy from the heat-yielding purification element to a fluid within a fluid inlet of the fluid distillation system is accomplished using a heat pipe. The method can also include the step of absorbing latent heat energy from purified fluid within an outlet of the fluid distillation system and transferring the latent heat energy to the fluid within the fluid inlet, causing the fluid to be heated.

Another aspect includes an energy-efficient distillation system including a heat-yielding purification element, a heat-receiving element, and a heat pipe. The heat pipe includes a first end, a second end, and a body therebetween. The first end is operably connected to the heat-yielding purification element and the second end is operably connected to the heat-receiving element. The heat pipe is configured to transfer latent heat energy from the first end to the second end, thereby heating a fluid within the heat-receiving element. The heat-yielding purification element can be an evaporation chamber, a degasser, a demister, or a condenser. The heat-receiving element can be a fluid heater. The fluid heater can heat fluid at a fluid inlet to the system, such that fluid entering the system is pre-heated prior to downstream processing of the fluid. The fluid heater can heat fluid in a hot-fluid storage chamber.

### BRIEF DESCRIPTION OF THE DRAWINGS

FIG. 1 is a cross-sectional diagram of a heat pipe.

FIG. 2 is a diagram of a heat recovery system for an advanced water distillation system.

FIG. 3 shows an embodiment for recovering heat from a degasser.

FIG. 4 is a diagram illustrating the heat recovery system for a demister.

FIG. 5 is a diagram describing a heat recovery system for product water.

FIG. 6 is a diagram that shows heat recovery from boiler drainage.

FIG. 7 is a diagram of an integrated heat recovery system.

FIG. 8 is a diagram of an integrated heat recovery system, including electromagnetic descalers.

### DETAILED DESCRIPTION OF THE PREFERRED EMBODIMENT

The present invention includes a compact, more effective heat recycling system that can be utilized to recover heat from distillation units without the need for heat exchangers. The inventive concept includes using different configurations of heat pipes that transfer heat from hot waste or product streams to an incoming feed fluid, e.g., water, so as to minimize overall heat requirements for a fluid purification system. Heat pipes rely on the principle of enthalpy transport to transfer heat from one point to another, and they normally require a phase change in the fluid used to transfer heat. Because phase change, from liquid to vapor or solid to vapor (e.g., sublimation) or vice-versa, is always associated with the heat of vaporization or condensation (or heat of sublimation in the case of solids), and because such heats of vaporization are normally very substantial when compared with the specific heat conductivities of most materials, the intrinsic efficiencies of a heat pipe are significantly higher than those of heat exchangers.

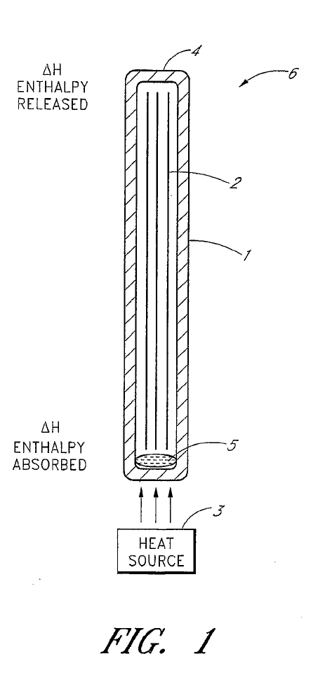

The principle of operation of a heat pipe is described by reference to FIG. 1. The heat pipe includes a first end, a second end, and a body therebetween. The heat pipe can be, in some embodiments, a sealed tube under partial vacuum 1, containing a number of capillary fibers or tubes, also known in the art as a wick, 2 and a working fluid, which can also be a solid 5. However, the heat pipe need not necessarily be a tube, or even substantially tubular, but rather can be any other shape conducive to heat transfer. When heat is applied to one end of the heat pipe by a heat source 3, a portion of the working fluid or solid 5 evaporates by absorbing heat ΔH, the enthalpy of vaporization of such fluid. Because the tube is under partial vacuum, the vapor that is created rapidly fills the tube and reaches the unheated (cold) end of the heat pipe 4. The speed of propagation of such vapor is extremely high, and of the order of the speed of sound. As soon as the vapor inside the heat pipe reaches the cold end of the tube 4, it releases the same enthalpy as the vapor condenses into a fluid again, thus transferring the same amount of heat from the hot to the cold ends of the tube. Once the vapor condenses into liquid, it travels by capillary action through the wick 2 to the original end of the tube, where the process can begin again. Condensation and evaporation phenomena occur continuously and, aside from heat losses that can occur along the length of the heat pipe, which can be minimized by means of proper insulation, the process is thermodynamically reversible, i.e., it is theoretically 100% efficient. Some examples of heat pipes include U.S. Pat. Nos. 3,229,759 and 3,554,183 to Grover, 4,108,239 to Fries, and 4,921,041 to Adachi, each of which is incorporated by reference herein.

In practice, heat pipes are designed to minimize heat conduction losses, while optimizing working fluid recycling through the tube. The system disclosed can be energy-efficient. In some embodiments, the energy-efficient system has a thermal efficiency, or percentage of heat recovered (rather than lost to the environment), of at least 90%, 91%, 92%, 93%, 94%, 95%, 96%, 97%, 98%, 99%, 99.5%, or more. In the present invention, the heat pipes are preferably made of metal. Non-limiting examples of various usable metals including steel, stainless steel, copper, aluminum, titanium, nickel, zinc, or an alloy, although one can employ other materials, such as ceramics, glass, or polymers, or a laminate of multiple materials. The heat pipe can be any size or shape, depending on the size of the water purification system to be constructed, or if transferring heat to external devices is desired. In a preferred embodiment, the heat pipe has a first end, a second end, and a body therebetween, and is manufactured of thin gauge stainless steel tubes, able to withstand a vacuum of between 0-760 mm Hg, preferably a moderate vacuum, in the range of approximately 100-700 mmHg, and are filled with preferably water or similar working fluid. Non-limiting examples of possible working fluids include methanol, ethanol, isopropyl or other alcohols, ammonia, acetone, Flutec PP2, toluene, or other volatile organic compounds. Moreover, a solid that sublimates (preferably at a temperature of less than 300° C.) can be utilized as a working fluid as well. Furthermore, the heat pipe preferably contains capillary media such as thin bundles of glass, carbon fibers, ceramics, or metal fibers. Alternatively, the capillary media can be made of sintered porous materials, such as metals or oxidized metal powders. The capillary media can be hydrophilic or hydrophobic, depending on the properties of the working fluid, and have a range of pore sizes. Also, the capillary media can be arranged in many ways, the most common being a sintered powder, grooved tube, or screen mesh format. The use of capillary media inside the heat pipe allows heat transfer to proceed with any orientation of the heat pipe.

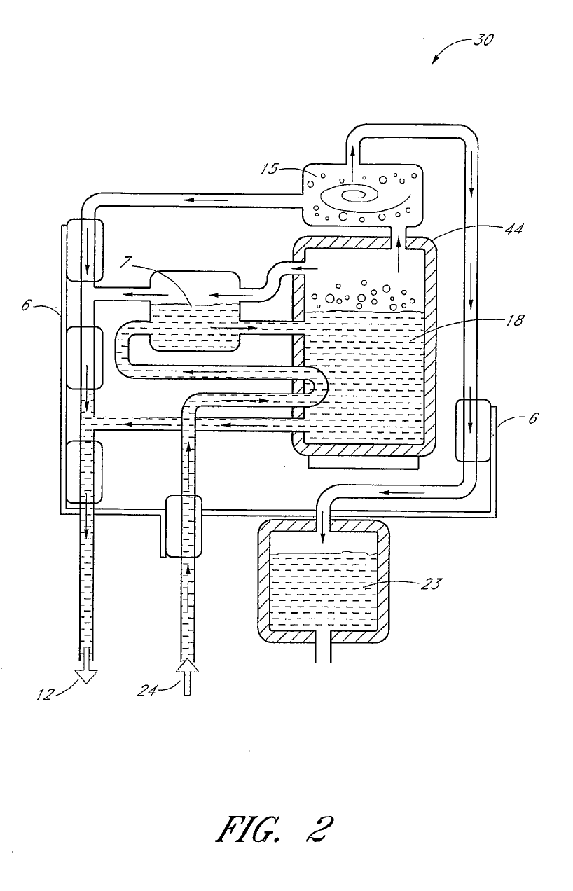

Heat pipes 6 can be utilized to recover heat from a distillation unit 30, such as shown in FIG. 2. FIG. 2 depicts an advanced distillation system 30 that entails preheating of the incoming fluid 24 by using heat pipes 6 that recover energy from both hot waste and product streams. The system 30 can include several heat-yielding purification elements. Some non-limiting examples of heat-yielding purification elements include degassers, demisters, evaporation chambers, and condensers. The preheated water, which can be further preheated by passing the incoming water line 24 through a boiler 18, then enters the top of a vertical degasser 7 where volatile gases and organic chemicals are stripped off by counter-current steam. The stripped gases and organic chemicals exit the top of the degasser 7 with some steam and carry a significant amount of latent heat which is absorbed by a heat pipe 6. That heat is then transferred by the heat pipe 6 to the incoming water, so as to recover most of its energy. The incoming water, already stripped of volatile gases and organic contaminants then enters an evaporating chamber 44, where it is turned into steam. Part of the steam produced in the evaporating chamber 44 is used to strip gases and organic contaminants in the degasser 7, and part enters a cyclone demister 15 where mist droplets containing salts and other non-volatile contaminants are separated by centrifugal action from clean steam. The waste stream from the demister 15, which contains significant latent heat, is then contacted with a heat pipe 6 that absorbs most of that latent heat, again transferring such recovered heat to the incoming feed water 24. Clean steam from the demister 15, which contains most of the latent heat of the distillation system 30, is passed to a heat pipe 6 that absorbs not only the latent heat of evaporation of such steam, but also the heat contained in hot product water 23. Most of the contained heat from the product stream 23 is absorbed by the heat pipe 6 and is transferred to the incoming water stream 24. In addition, the hot boiling water in the evaporation chamber 44, which progressively concentrates non-volatile impurities, is periodically drained through another heat pipe 6 that recovers most of that heat and transfers it to incoming water stream 24. One of ordinary skill in the art will recognize that other fluids other than water, e.g., alcohols or other solvents, can be distilled in a similar manner.

Utilization of one or more heat pipes 6 instead of a heat exchanger, such as a plated heat exchanger, can be advantageous as transferring energy utilizing heat pipes 6 does not require direct contact between a heat-receiving element, such as a fluid inlet, and a heat-yielding purification element, as described above.

Other various distillation systems that can be modified for use with the present invention are described in, for example, U.S. patent application Ser. No. 11/444,911 to Thom et al, filed May 31, 2006; U.S. patent application Ser. No. 11/444,912 to Lum et al, filed May 31, 2006; PCT Application No. PCT/US2006/025994, filed Apr. 28, 2006; and U.S. patent application Ser. No. 11/255,083 to Deep et al, filed Oct. 19, 2005, each of which is incorporated by reference in their entirety.

It should be clear to those skilled in the art that the embodiment described in FIG. 2 is only one possible configuration of an advanced distillation system comprising degassing, demisting, water evaporation, and heat recovery. In this particular embodiment, there are multiple heat sources, for example, heat-yielding purification elements, all connected to a single heat pipe 6, and that composite heat-recovery system 30 delivers the enthalpy of such multiple heat sources to the incoming water stream.

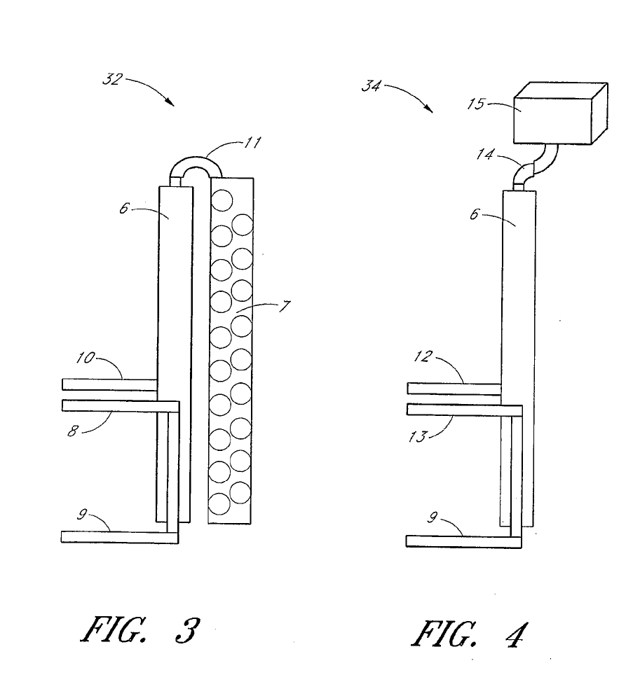

In some alternative embodiments, such as shown in FIGS. 3, 4, 5, and 6, individual heat pipes 6 transfer heat progressively to the incoming water stream 24, so that its temperature increases progressively toward that of the boiling point of water. For example, FIG. 3 shows an embodiment of a heat recovery system 32 comprising a heat pipe 6 that recovers energy from a degasser stream 11. In FIG. 3, hot steam and gases 11 exit through the top of degasser 7 and transfer most of the contained heat to heat pipe 6 thereby cooling the degasser waste stream 10, which can be then rejected via a drain. The heat absorbed by degasser 6 is then transferred to the incoming water stream 8, thus raising the temperature of the pre-heated water 9.

A key factor in degasser performance is mass transfer ratio: the mass of water going downward in a vertical degasser as compared to the mass of steam going upward. Indeed, degassing function can be accomplished with various configurations that permit mass-transfer counterflow of water with a gas. In some embodiments, the gas is steam; in others the gas can be air, nitrogen, and the like. The velocity and activity of mixing of water with steam is affected by the size, conformation, and packing of the degasser column medium, as well as the void volume between the particles of the medium. In preferred embodiments, the particles of the medium pack to form a spiral. The performance of the degasser is affected by the velocity and volume of steam and water passing therethrough; these can be controlled by such factors as the size of the steam inlet and outlet orifice, water flow rate, and the like. Useful information relating to degasser function and design is provided in Williams, Robert The Geometrical Foundation of Natural Structure: A Source Book of Design, New York: Dover, 1979, which is incorporated herein by reference in its entirety.

Control of inlet water flow rate, avoidance of large steam bubbles in the preheat tube, and the like, can therefore aid efficient function of the degasser. When these parameters are not within a desirable range, flooding or jetting can occur in the degasser. Flooding of inlet water forms a water plug in the degasser and jetting shoots water out of the degasser with the steam, either of which can interfere with degasser performance. It is therefore desirable to operate in a zone that minimizes flooding and jetting and that has a good balance between water influx and steam efflux. The degasser of embodiments of the present invention is particularly important in that it is not designed to remove strictly one contaminant as many conventional degassers are. Instead it removes a variety of contaminants very effectively. In typical settings, where the inlet water has a contaminant at, for example, 1 ppm the process seeks to achieve reduction to 50, 40, 10, 5, 2, or 1 ppb.

FIG. 4 illustrates another heat recovery system 34 where the heat from the demister waste stream 14 is absorbed by a separate heat pipe 6 thereby cooling it prior to its discharge through a drain as cold demister waste 12, and the recovered heat is transferred to the pre-heated water stream 13 to further raise the temperature of the pre-heated hot water 9.

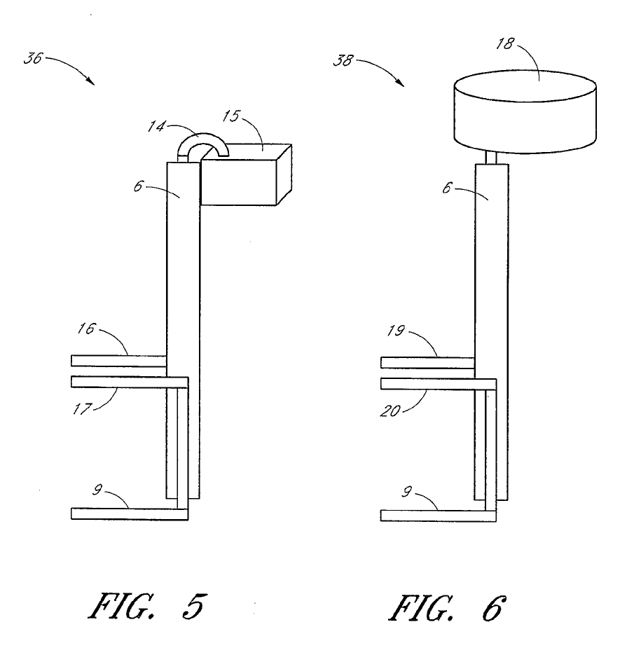

In another embodiment of a heat recovery system 36, as shown in FIG. 5, the heat contained in the clean product steam from demister 15 is absorbed by heat pipe 6 in order to achieve steam condensation and cooling of the product water 16, and the recovered heat is transferred and used to further heat the pre-heated water stream, which enters the cold end of the heat pipe as cold/warm incoming water 17, and leaves as hot water 9.

Various kinds of demisters 15 are known in the known in the art, including those employing screens, baffles, and the like, to separate steam from mist based upon size and mobility. Preferred demisters 15 are those that employ cyclonic action to separate steam from mist based upon differential density. Cyclones work on the principle of moving a fluid or gas at high velocities in a radial motion, exerting centrifugal force on the components of the fluid or gas. Conventional cyclones have a conical section that in some cases can aid in the angular acceleration. However, in preferred embodiments, the cyclone demisters employed in the system do not have a conical section, but are instead essentially flat. Key parameters controlling the efficiency of the cyclone separation are the size of the steam inlet, the size of the two outlets, for clean steam and for contaminant-laden mist, and the pressure differential between the entry point and the outlet points.

The demister 15 is typically positioned within or above the evaporation chamber 18, permitting steam from the chamber 18 to enter the demister 15 through an inlet orifice. Steam entering a demister 15 through such an orifice has an initial velocity that is primarily a function of the pressure differential between the evaporation chamber 18 and the demister 15, and the configuration of the orifice. Typically, the pressure differential across the demister 15 is about 0.5 to 10 column inches of water—about 125 to 2500 Pa. The inlet orifice is generally designed to not provide significant resistance to entry of steam into the cyclone. Steam then can be further accelerated by its passing through an acceleration orifice that is, for example, significantly narrower than the inlet orifice. At high velocities, the clean steam, relatively much less dense than the mist, migrates toward the center of the cyclone, while the mist moves toward the periphery. A clean steam outlet positioned in the center of the cyclone provides an exit point for the clean steam, while a mist outlet positioned near the periphery of the cyclone permits efflux of mist from the demister 15. Clean steam passes from the demister 15 to a condenser, while mist is directed to waste. In typical operation, clean steam to mist ratios are at least about 2:1; more commonly 3:1, 4:1, 5:1, or 6:1; preferably 7:1, 8:1, 9:1, or 10:1, and most preferably greater than 10:1. Demister selectivity can be adjusted based upon several factors including, for example, position and size of the clean steam exit opening, pressure differential across the demister, configuration and dimensions of the demister, and the like. Further information regarding demister design is provided in U.S. Provisional Patent Application No. 60/697,107 entitled, IMPROVED CYCLONE DEMISTER, filed Jul. 6, 2005, which is incorporated herein by reference in its entirety. The demisters disclosed herein are extremely efficient in removal of submicron-level contaminants. In contrast, demisters of other designs such as, for example, screen-type and baffle-type demisters, are much less effective at removing submicron-level contaminants.

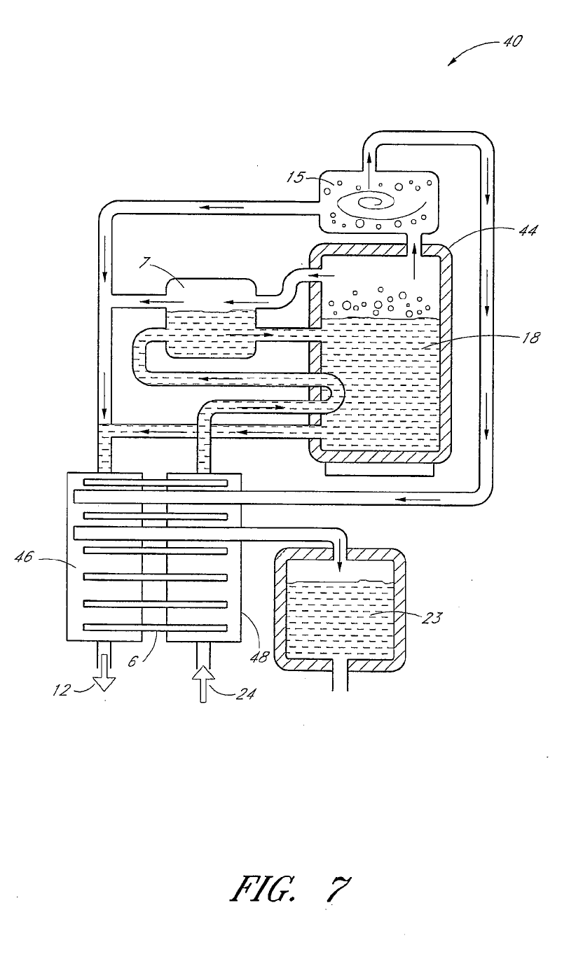

FIG. 6 describes an embodiment of a heat recovery system 38 where heat is recovered from the periodic drainage of the evaporating chamber 18, in which heat pipe 6 absorbs the contained heat of the boiler waste heat, and yields a cold boiler waste 19, and transfers the heat recovered to the preheating water stream, which enters the cold end of the heat pipe as cold/warm incoming water 20 and leaves as hot pre-heated water 9.

The evaporation chamber 18 can be of essentially any size and configuration depending upon the desired throughput of the system and other design choices made based upon the factors effecting system design. For example, the evaporation chamber 18 can have a volume capacity of about 1 gallon or 2-10 gallons, 11-100 gallons, 101-1000 gallons, or more. Because the system of the invention is completely scalable, the size of the evaporation chamber 18 is variable and can be selected as desired. Likewise, the configuration of the evaporation chamber 18 can be varied as desired. For example, the evaporation chamber 18 can be cylindrical, spherical, rectangular, or any other shape.

In preferred embodiments, a lower portion of the evaporation chamber 18 is stepped to have a smaller cross-sectional area than the upper section of the chamber. Above the step is preferably a drain, such that upon draining, residual water remains below the step. The portion of the evaporation chamber 18 below the step can also accommodate a cleaning medium such that after drainage all cleaning medium and some residual water is held in the lower portion. The benefit of the lower portion is that after rapid drainage of the evaporation chamber 18, heat can again be applied to the evaporation chamber 18, permitting rapid generation of steam prior to arrival of the first new inlet water into the evaporation chamber 18. This initial generation of steam permits steam flow through the degasser to achieve a steady state when a new cycle begins, which is beneficial to efficiently degassing of the inlet water. Likewise, a residual amount of water in the evaporation chamber 18 avoids dry heating of the evaporation chamber 18 which can be detrimental to the durability and stability of the chamber itself as well as the self-cleaning medium.

In some embodiments, the evaporation chamber 18 drains by gravity only, in other embodiments draining the evaporation chamber 18 is driven by pumping action. It is desirable that the evaporation chamber 18 drain rapidly, to avoid the settling of sediments, salts, and other particulates. Rapid draining is preferably on the order of less than 30 seconds, although draining that is less rapid can still achieve substantially the desired benefits of avoiding settling and so on.

Furthermore, many combination heat recovery systems, for example, combining various elements of FIGS. 3-6 are possible, thus utilizing a plurality of heat pipes in some embodiments. In some embodiments, systems can include 2, 3, 4, 5, 6, 7, 8, 9, 10, or more heat pipes.

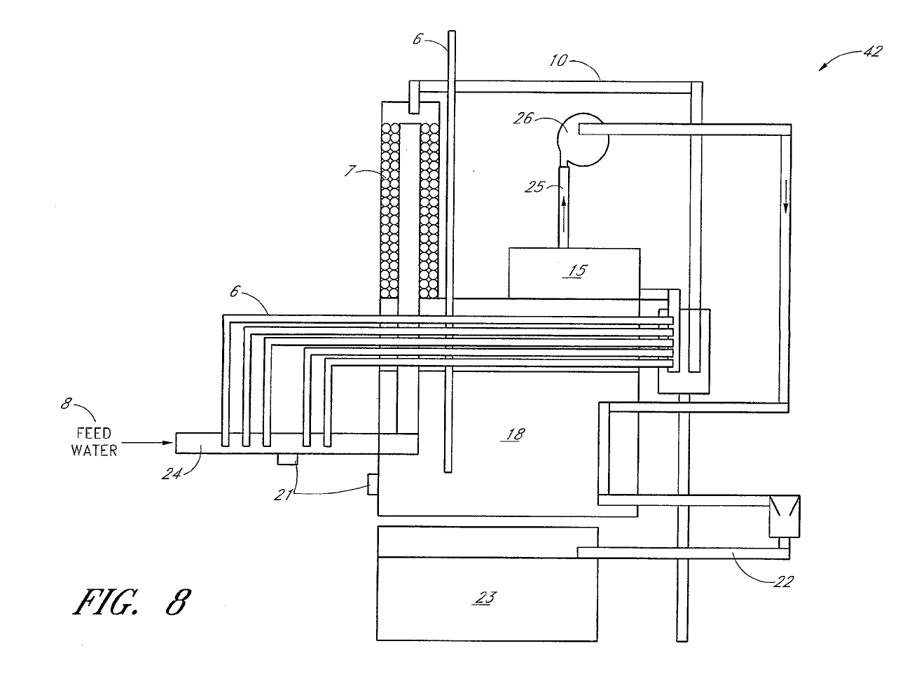

FIG. 7 shows an embodiment in which the various heat pipes 6 described in connection with FIGS. 3-6 are integrated into a composite system. In FIG. 7, the various waste streams from the degasser 7, demister 15, and boiler 18 are combined into a waste heat reservoir 46 that is thermally well insulated, and heat from product water 23 condensation and cooling is added to this reservoir 46. The incoming feed water 24 to the entire distillation unit 40 enters a similar holding tank 48 that is also well insulated, and heat is transferred from the hot 46 to the cold holding tanks 48 by a series of heat pipes 6.

Those skilled in the art will recognize that other embodiments involving heat recovery from degassing, demisting, and evaporating chambers are possible. For example, the heat recovered from a hot-fluid storage chamber in FIG. 7 can be transferred outside the distillation system to be utilized in other heat-receiving elements, for example, water-heaters, washing machines, or other appliances, thus effecting a similar energy recovery function for a household, commercial entity, manufacturing plant, and the like. Alternatively, sources of pre-heated water, such as from a water-heater, can be utilized directly by the advanced distillation unit, such that the net energy savings of an integrated thermal recovery system are similar to those described in the present invention. As noted above, the thermal efficiency of such a system may be about 90%, 91%, 92%, 93%, 94%, 95%, 96%, 97%, 98%, 99%, 99.5%, or more.

In some embodiments, electromagnetic fields can be superimposed to the incoming flow of water into a distiller, and similar electromagnetic fields to the water contained in the boiling chamber. It is well known that electrical or magnetic fields excite ionized species, particularly those that are found in aqueous solutions containing high concentrations of calcium, magnesium, and phosphate ions. When such ions are excited, they precipitate in different crystallographic form from those normally encountered in hard-scale formation. For example, calcium ions can precipitate in the form of aragonite instead of calcite. Aragonite can be less adhering to solid surfaces, and can also form softer and less dense solid phases that are easier to maintain in suspension. The mechanism of scale control is similar for electrical or magnetic fields and, thus, any form of electromagnetic energy can have similar effect. However, preferably the voltage imposed on a pair of electrodes should be sufficiently small to prevent electrical losses due to electrolysis of water, for example, less than 10, 9, 8, 7, 6, 5, 4, 3, 2, 1, 0.75, 0.5, or less volts. One particular embodiment uses pairs of electrodes such as used for measuring aqueous conductivity for the dual purpose of scale control and to simultaneously measuring electrical conductivity. In other embodiments, mechanical or chemical descalers can be alternatively utilized. Some examples of descalers include U.S. Pat. Nos. 5,378,362 to Schoepe and 6,171,504 to Patterson, both of which are incorporated by reference in their entirety.

FIG. 8 illustrates a preferred embodiment of an advanced distillation system 42 with two electromagnetic cells 21, one at the water inlet, and another in the boiling chamber. In the embodiment shown in FIG. 8, feed water 8 enters the system via a water inlet 24 where an electromagnetic descaler 21 excites ions resident in the water 8 and reduces scale formation via the above described mechanism. The feed water 8 is also heated by heat pipes 6 for pre-heating prior to the water entering a boiler 18, which also contains an electromagnetic descaler 21 in this embodiment. The water vaporizes into steam and then enters a degasser 7 where energy from waste gases 10 leaving the degasser 7 can be transferred via heat pipes 6 to water in the boiler 18. Vapor also enters a demister 15 which further removes waste and produces clean steam 25 that enters a vapor compressor 26. The clean steam 25 cools in a refrigerating loop 22 and becomes product water stored in a product tank 23. Product tanks 23 can be of any suitable composition that resists corrosion and oxidation. Preferred compositions for storage tanks 23 include stainless steel, plastics including polypropylene, and the like. In some embodiments, the storage tank 23 includes controls to avoid overflow and/or detect water level. Such controls can attenuate flow of inlet water and/or other functions of the system such that production of product water is responsive to demand therefore. Although product water entering the storage tank 23 is extremely clean and essentially sterile, it can be desirable to provide an optional cleaning/sterilization function in the storage tank 23, in case an external contaminant enters the tank 23 and compromises the cleanliness thereof.

Within the storage tank 23 can be various controls for feedback to the overall control system. In preferred embodiments, these controls can include a float switch for feedback to control the flow of inlet water, and a conductivity meter to detect dissolved solids in the product water. In typical operation, dissolved solids in the product water will be exceedingly low. However, if a contaminant were to be deposited into the storage tank, such as for example by a rodent or insect, the resulting contamination would increase the conductivity of the water. The conductivity meter can detect such an elevation of conductivity and provide an indication that it can be advisable to initiate a steam-sterilization cycle of the storage tank 23. The control system can have the capability of draining the water from the storage tank 23, sending a continuous supply of steam into the storage tank 23 to clean and sterilize it, and then re-start a water purification cycle. These operations can be manually controlled or automatically controlled, in various embodiments of the invention.

Water can be delivered from the storage tank to an outlet, such as a faucet, and such delivery can be mediated by gravity and/or by a pump. In preferred embodiments, the pump is an on-demand pump that maintains a constant pressure at the outlet, so that water flow from the outlet is substantial and consistent. The outlet pump can be controlled by a sensor in the storage tank to avoid dry running of the pump if the water level in the tank is below a critical level.

One skilled in the art will recognize that the embodiment described in FIG. 8 is only one possible configuration of an advanced distillation system comprising degassing 7, demisting 15, water evaporation 44, heat recovery 6, and hard-scale control 21 elements. In other embodiments, the electromagnetic fields are generated by permanent magnets or electromagnets, or even by alternating current. Moreover, in alternate embodiments, a distillation system can contain more or less electromagnetic cells 21, such as just one cell, or three, four, five, six, seven, eight, or more cells. For example, there can be multiple descalers 21 in the water inlet 24 or boiler 18, or as other locations, such as, for example, in the product tank 23.

In some embodiments, the system for purifying water, embodiments of which are disclosed herein, can be combined with other systems and devices to provide further beneficial features. For example, the system can be used in conjunction with any of the devices or methods disclosed in U.S. Provisional Patent Application No. 60/676,870 entitled, SOLAR ALIGNMENT DEVICE, filed May 2, 2005; U.S. Provisional Patent Application No. 60/697,104 entitled, VISUAL WATER FLOW INDICATOR, filed Jul. 6, 2005; U.S. Provisional Patent Application No. 60/697,106 entitled, APPARATUS FOR RESTORING THE MINERAL CONTENT OF DRINKING WATER, filed Jul. 6, 2005; U.S. Provisional Patent Application No. 60/697,107 entitled, IMPROVED CYCLONE DEMISTER, filed Jul. 6, 2005; PCT Application No: US2004/039993, filed Dec. 1, 2004; PCT Application No: US2004/039991, filed Dec. 1, 2004; and U.S. Provisional Patent Application No. 60/526,580, filed Dec. 2, 2003; each of the foregoing applications is hereby incorporated by reference in its entirety.

One skilled in the art will appreciate that these methods and devices are and can be adapted to carry out the objects and obtain the ends and advantages mentioned, as well as various other advantages and benefits. The methods, procedures, and devices described herein are presently representative of preferred embodiments and are exemplary and are not intended as limitations on the scope of the invention. Changes therein and other uses will occur to those skilled in the art which are encompassed within the spirit of the invention and are defined by the scope of the disclosure.

It will be apparent to one skilled in the art that varying substitutions and modifications can be made to the invention disclosed herein without departing from the scope and spirit of the invention.

Those skilled in the art recognize that the aspects and embodiments of the invention set forth herein can be practiced separate from each other or in conjunction with each other. Therefore, combinations of separate embodiments are within the scope of the invention as disclosed herein.

All patents and publications are herein incorporated by reference to the same extent as if each individual publication was specifically and individually indicated to be incorporated by reference.

The invention illustratively described herein suitably can be practiced in the absence of any element or elements, limitation or limitations which is not specifically disclosed herein. The terms and expressions which have been employed are used as terms of description and not of limitation, and there is no intention that in the use of such terms and expressions indicates the exclusion of equivalents of the features shown and described or portions thereof. It is recognized that various modifications are possible within the scope of the invention disclosed. Thus, it should be understood that although the present invention has been specifically disclosed by preferred embodiments and optional features, modification and variation of the concepts herein disclosed can be resorted to by those skilled in the art, and that such modifications and variations are considered to be within the scope of this invention as defined by the disclosure.

I claim:

1. An energy-efficient distillation system, comprising:
a fluid inlet;
a heat-yielding purification element downstream of the fluid inlet;
a first heat pipe with a first end, a second end, and a body therebetween; said first end operably connected to the heat-yielding purification element and said second end operably connected to the fluid inlet; said heat pipe configured to transfer latent heat energy from the first end to the second end, thereby heating a fluid within the fluid inlet; and;
a fluid outlet downstream of the heat-yielding purification element and configured to receive a purified fluid from the heat-yielding purification element.

2. The distillation system of claim 1, wherein the heat-yielding purification element is a degasser.

3. The distillation system of claim 1, wherein the heat-yielding purification element is a demister.

4. The distillation system of claim 1, wherein the heat-yielding purification element is an evaporation chamber.

5. The distillation system of claim 1, further comprising a second heat pipe with a first end, a second end, and a generally tubular body; said second heat pipe operably connected to the fluid outlet at a first end and the fluid inlet at a second end; said second heat pipe configured to transfer latent heat energy from the fluid outlet to the fluid inlet, thereby heating the fluid within the fluid inlet.

6. The distillation system of claim 1, further comprising a descaling element configured to reduce scale formation of the fluid.

7. The distillation system of claim 6, wherein the descaling element reduces scale formation using magnetic energy.

8. The distillation system of claim 6, wherein the descaling element reduces scale formation using electromagnetic energy.

9. The distillation system of claim 1, wherein the heat pipe is configured to withstand a vacuum of between about 0-760 mm Hg without collapse.

10. The distillation system of claim 1, wherein the heat pipe is configured to withstand a vacuum of between about 100-700 mm Hg without collapse.

11. The distillation system of claim 1, wherein the heat pipe comprises a metal.

12. The distillation system of claim 11, wherein the metal is stainless steel.

13. The distillation system of claim 1, wherein the heat pipe further comprises capillary media.

14. A method of recovering heat within a fluid distillation system, comprising the steps of:
passing fluid through a heat-yielding purification element of the fluid distillation system;
absorbing latent heat energy from the heat-yielding purification element; and
transferring the latent heat energy from the heat-yielding purification element to a fluid within a fluid inlet of the fluid distillation system, causing the fluid to be heated.

15. The method of claim 14, further comprising the step of reducing scale formation of the fluid by excitation of ions within a fluid.

16. The method of claim 15, wherein excitation of ions within the fluid is performed using magnetic energy.

17. The method of claim 15, wherein excitation of ions within the fluid is performed using electromagnetic energy.

18. The method of claim 14, wherein absorbing latent heat energy from the heat-yielding purification element and transferring the latent heat energy from the heat-yielding purification element to a fluid within a fluid inlet of the fluid distillation system is accomplished using a heat pipe.

19. The method of claim 14, wherein the heat-yielding purification element is a degasser.

20. The method of claim 14, wherein the heat-yielding purification element is a demister.

21. The method of claim 14, wherein the heat-yielding purification element is an evaporation chamber.

22. The method of claim 14, further comprising the steps of:
absorbing latent heat energy from purified fluid within an outlet of the fluid distillation system; and
transferring the latent heat energy to the fluid within the fluid inlet, causing the fluid to be heated.

23. An energy-efficient distillation system, comprising:
a heat-yielding purification element;
a heat-receiving element; and
a first heat pipe with a first end, a second end, and a body therebetween; said first end operably connected to the heat-yielding purification element and said second end operably connected to the heat-yielding purification element and said second end operably connected to the heat-receiving element; said heat pipe configured to transfer latent heat energy from the first end to the second end, thereby heating a fluid within the heat-receiving element.

24. The distillation system of claim 23, wherein the heat-yielding purification element is selected from the group consisting of: an evaporation chamber, a degasser, a demister, and a condenser.

25. The distillation system of claim 23, wherein the heat-receiving element is a fluid heater.

26. The distillation system of claim 25, wherein the fluid heater heats fluid at a fluid inlet to the system, such that fluid entering the system is pre-heated prior to downstream processing of the fluid.

27. The distillation system of claim 25, wherein the fluid heater heats fluid in a hot-fluid storage chamber.
